(19) United States
(12) Patent Application Publication
(10) Pub. No.: US 2004/0188971 A1
(43) Pub. Date: Sep. 30, 2004

(54) Self-steering axle, trailer and vehicle system

(76) Inventors: Benito V. Rudder, Norco, CA (US); Jamal U. Qattan, North Hills, CA (US)

Correspondence Address: GORDON & REES LLP, 101 WEST BROADWAY, SUITE 1600, SAN DIEGO, CA, 92101, US

(21) Appl. No.: 10/406,098

(22) Filed: Mar. 31, 2003

(51) Int. Cl. B60G 1/00

(52) U.S. Cl. 280/124.111

(57) ABSTRACT

A self-steering axle assembly which can be supported to a vehicle includes an axle. A suspension and steering system interposed between the axle and the vehicle are rotatable as a unit around a motion axis of the axle. A pivotally supported member such as a platform can tilt to rotate the suspension and steering system. A mover such as a piston and cylinder assembly is connected to determine the angular displacement of the platform with respect to the vehicle. When the actuator is in a first position, caster is positive and when the platform is in a second position, caster is negative enabling the vehicle to self steer in the reverse mode. In a further embodiment, a vehicle or trailer is provided including a self-steering axle constructed in accordance with the present invention.

### BACKGROUND OF THE INVENTION

The present invention relates to self-steering axle assemblies, also often referred to as self-tracking assemblies, to vehicles incorporating such assemblies and a method of operation.

Most vehicles referred to as trailers are not true trailers. Commonly, they are “semi-trailers” rather than “trailers.” The technical distinction between these terms is highly significant in terms of their construction and in the nature of applications in which they may be employed. This distinction is recognized and well-documented in the art. For example, the California Transportation Code, §550 defines a semi-trailer as “a vehicle designed for carrying persons or property, used in conjunction with a motor vehicle, and so constructed that some part of its weight and that of its load rests upon, or is carried by, another vehicle.” The same code, at §630 defines a trailer as “a vehicle designed for carrying persons or property on its own structure and for being drawn by a motor vehicle and so constructed that no part of its weight rests upon any other vehicle. . . . ” “[T]railer” includes a semi-trailer when used in conjunction with an auxiliary dolly, if the auxiliary dolly is of a type constructed to replace the function of the draw bar and the front axle or axles of a trailer.”

A trailer or semi-trailer must be able to follow a vehicle which is pulling it. In order to be safely utilized and practically utilized, a pulling vehicle should also be able to back up a trailer and have some reasonable degree of control of steering of the trailer in a rearward direction. Semi-trailers can be pulled forward and backed up without the inclusion of special steering mechanisms in their axles.

The use of semi-trailers places certain requirements on the pulling vehicles. The pulling vehicle must be able to accommodate the tongue weight of the trailer. The tongue weight is the force applied at the point of attachment of the trailer to the pulling vehicle. Many traditional three point trailer, approximately 85% is supported by the axle, and tongue weight of approximately 15% is supported by the tow vehicle. Common small trailers such as single axle trailers used to tow boats or limited amounts of household goods have a tongue supported to a trailer hitch supported from the rear of a vehicle such as a car. Three point trailers can have more than one axle. For a safe operation, three point trailers require a particular balancing of a certain percentage of load in front of the axle and a certain percentage behind it. Wrong balancing may tend to lift rear wheels of the vehicle off the ground and creates a very unstable tow. Fishtailing and porpoising may result. Too much tongue weight will lift the front of the vehicle impeding the ability to steer. Gooseneck trailers are often used for large loads, and the tongue of the trailer is placed on the bed of a large vehicle such as flat bed truck or a pick up truck. While a large capacity may be accommodated, the bed of the truck is occupied by the gooseneck and not fully available for payloads. Trailer tongue weight decreases maximum payload of the towing vehicles.

Many utility trucks are not suitable for pulling a trailer. Common utility trucks are panel vans, electrical utility trucks, telephone utility trucks, road maintenance trucks and others. They may have some limited capacity to pull a small semi-trailer with a limited tongue weight. However, maximum pulling capacity of a vehicle is not utilized because it has to accommodate tongue weight. Engines are commonly proportioned to trucks such that the maximum balance load that could be pulled by a truck is greater than the tongue weight which the truck could accept. It would therefore be highly desirable to provide a trailer capable of being towed by a truck when the truck is loaded.

Another problem encountered is in backing up trailers. Many trailers effectively cannot easily be backed up. A prior art solution for this problem is the provision of a self-steering axle unit. These devices provide variable selectable caster angle. Caster is defined as an angle between a vertical direction and the inclination of the axis about which wheels turn for steering. This axis is commonly determined by placement of a king pin. The wheels are directed to the right or the left by rotation about the king pin. When the king pin is canted such that the top of the king pin is horizontally behind the bottom of the king pin for motion in a forward direction, caster is positive. The king pin is canted so that the top of the king pin is horizontally ahead of the bottom of the king pin where motion in reversed direction, caster is negative. It is desirable to provide a positive caster for travel in a forward direction, and negative caster for travel in a rearward direction. Nominal caster angles are ±5°.

Several prior art patents disclose axle assemblies in which positive caster is selected for forward movement and negative caster is selected for rearward movement. A common thread in many of these arrangements is that the axle must be moved with respect to the trailer in order to shift the caster from one polarity to the other. This of necessity requires the assembly to overcome forces due to weight supported by a vehicle suspension with the spring bias of the suspension system. This requires use of heavy duty components compared to a system that could be constructed if it were not required to overcome supported weights.

Self-steering, or self tracking axle assemblies have great utility in multi-axle vehicles as well as in trailers. Self-steering axles can reduce a truck's tail swing. By providing the self-steering, or self tracking, support wheels, support wheels on tag (auxiliary axles) can be kept in contact with the ground and need not be lifted irrespective of direction of travel of the truck. Consequently, maximum capacity of the truck is utilized.

### SUMMARY OF THE INVENTION

Briefly stated, in accordance with the self-steering axle aspect of the present invention, there is provided an axle assembly which can support a vehicle. A steering system and a suspension interposed between the axle and the vehicle. The steering system and suspension are rotatable as a unit with a structural member such as a tilting platform to determine angular position of the steering system and suspension. A mover such as an actuator is connected to determine the angular displacement of the platform with respect to the vehicle. When the platform is in a first position, caster is positive and when the platform is in a second position, caster is negative. Positive caster enables self-steering in the forward direction. Negative caster enables self-steering in the reverse mode.

In a further embodiment, a trailer is provided including a self-steering axle constructed in accordance with the prior embodiment. The trailer is arranged to be a true trailer in that a virtually zero tongue weight is imposed on the towing vehicle. Consequently, full gross weight capacity of the towing vehicle is utilized. A tow bar is affixed to the trailer. The axle carrying the steering wheels does not turn with respect to the trailer. The wheels track, and not the entire axle.

In an additional embodiment, a truck or other vehicle includes an axle assembly of the type described. In another embodiment, a method is provided in which a suspension system including a component defining a rotational axis determining caster, is rotated about a motion axis coaxial with the axes of the wheel spindles, from a first position providing positive caster, to a second position providing negative caster.

### BRIEF DESCRIPTION OF THE DRAWINGS

The invention is further described by reference to the following description taken in connection with the following drawings.

Of the drawings:

FIGS. 1 and 2 are respectively an elevation and a bottom view of a truck constructed in accordance with the present invention including a tag axle;

FIGS. 3 and 4 are respectively an elevation and a bottom view of a truck constructed in accordance with the present invention including forward pusher and rear tag axles;

FIGS. 5, 6, and 7 are respectively an isometric view, an elevation and a bottom view of a self-steering trailer constructed in accordance with the present invention;

FIG. 8 is a top view of a self-steering axle constructed in accordance with the present invention affixed to and cooperating with a vehicle, shown partially broken away, which could be a trailer or driven vehicle;

FIG. 9 is a top isometric view of a steering axle assembly;

FIG. 10 is a partial detailed view of FIG. 9, illustrating a spindle unit pivotable on a king pin and illustrating caster;

FIG. 11 is a plan view of a self-steering axle assembly constructed in accordance with the present invention and including a platform assembly which may interact with the suspension of FIG. 9;

FIG. 12 is a bottom isometric view of a platform assembly pivotally mounted to a frame;

FIG. 13 is an exploded isometric view of the self-steering axle of the present invention with platform and frame components;

FIG. 14 is a partial detailed isometric view of an embodiment in which the platform assembly interacts with an underside of a vehicle rather than a separate frame;

FIGS. 15 and 16 are partial cross-sectional views taken along line 15-15 of FIG. 8 illustrating the platform assembly further including a frame in a first position corresponding to positive caster and a second position corresponding to negative caster respectively;

FIG. 17 is an upper isometric view of a further embodiment of the self-steering axle assembly incorporating an alternative form of suspension;

FIGS. 18 and 19 are respectively an isometric view and a plan view of the steering axle assembly of FIG. 17 with the platform assembly removed therefrom;

FIG. 20 is an isometric view of a tiltable platform component of a platform assembly adapted to interact with the suspension in the embodiment of FIG. 17; and

FIG. 21 is an electrical diagram of an embodiment of the present invention.

### DETAILED DESCRIPTION

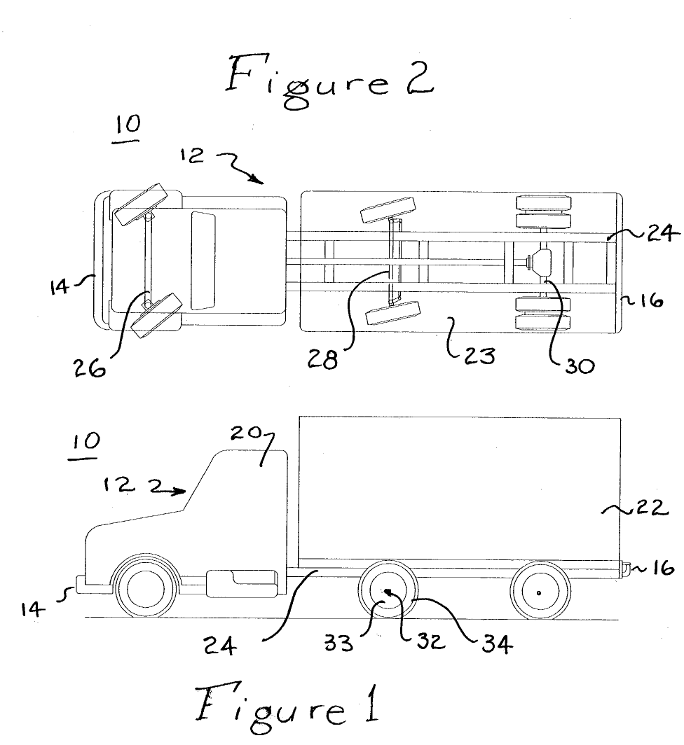

FIGS. 1 and 2 are respectively an elevation and a bottom view of a vehicle 10 comprising in the present embodiment a truck 12 constructed in accordance with the present invention. The vehicle 10 has a front 14 and a rear 16. The truck 12 has a cab 20 which normally houses an engine and a steering mechanism. A cargo compartment 22 is supported rearwardly of the cab 20 on a frame 24. The cargo compartment 22 may be a closed compartment, a flat bed or an open compartment. In the illustrated embodiment, the cargo compartment 22 is a container having a bottom surface 23. Alternatively, the compartment 22 may comprise any conventional payload-bearing apparatus, e.g. a boat support. The truck 12 has a forwardly disposed steering axle 26, an intermediate, pusher axle 28 and a rear-drive axle 30. A tag or pusher axle normally neither drives nor steers, but provides weight support. In the present embodiment, the pusher axle is made to be self-steering. Each of the axles 26, 28 and 30 has a hub 32 with a wheel 33 rotating thereon. A tire 34 is mounted to each wheel 33.

Providing for a self steering pusher axle 28 provides many operating advantages. A self-steering axle provides safety in that tracks the motion of the truck 12. Tracking stability increases as weight increases. The use of self-steering axles is being legislated by transportation ministries in Europe because they are recognized as significantly safer for narrow, winding highways and streets. Legislation is also in process in Canada.

In the case of a triaxle trailer or a triaxle truck fitted with rigid axles, as the central axle 28 pulled through a turn, the tires 34 are forced to slide across a road surface. Because the axles have no steering capability, they can only follow the direction of the truck by sliding sideways. This sliding creates scrub forces which reduce tire life and increase fuel consumption. These scrub forces also produce wear and tear on the truck chassis. Self-steering axles are also referred to a self-tracking axles.

In accordance with the present invention, and as further illustrated below, the vehicle 10 is an interactive part of a system including self-steering apparatus. In alternative embodiments, a separate self-steering axle assembly may be provided.

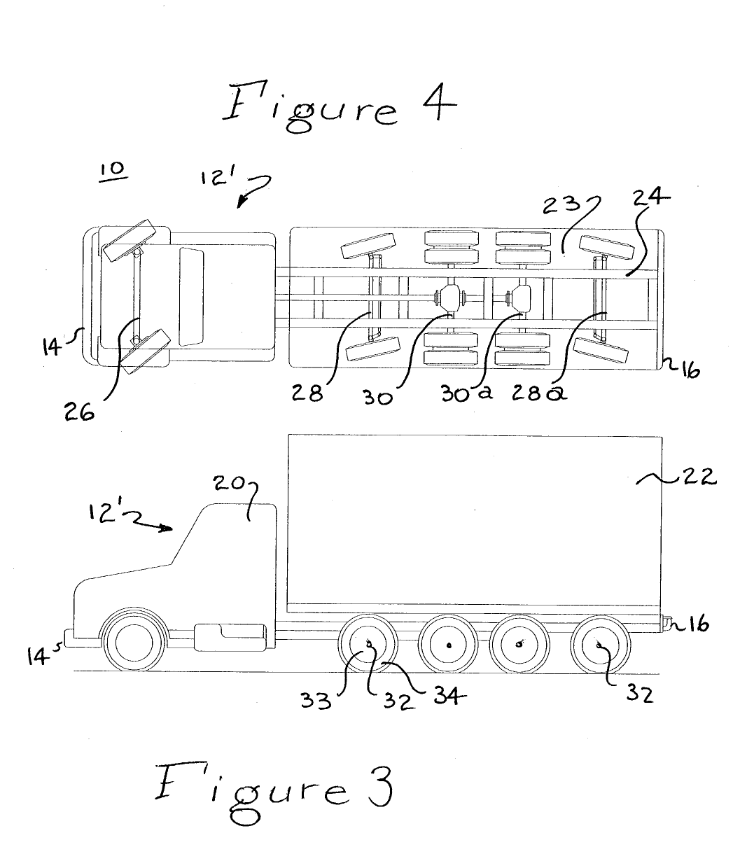

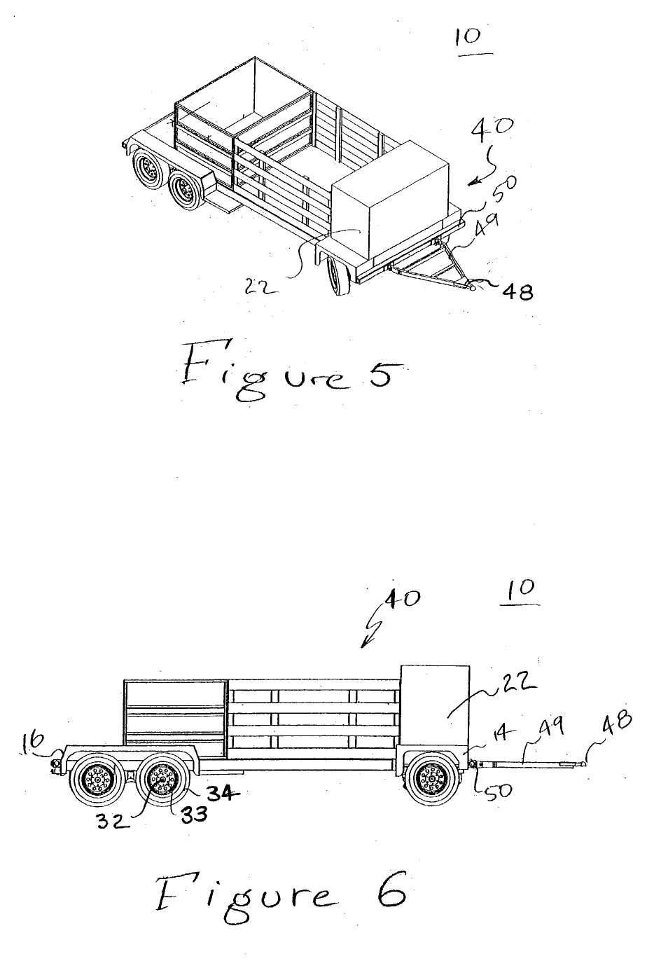

FIGS. 3 and 4 are respectively an elevation and a bottom view of a truck 12′ having an extended length. The truck 12′ has a pusher axle 28 and a drive axle 30. The truck 12′ also has a second drive axle 30a and a tag axle 28a disposed rearwardly of the drive axle 30. The truck 12′ is of such a length that scrub forces on the tag axle 30a would be significant.

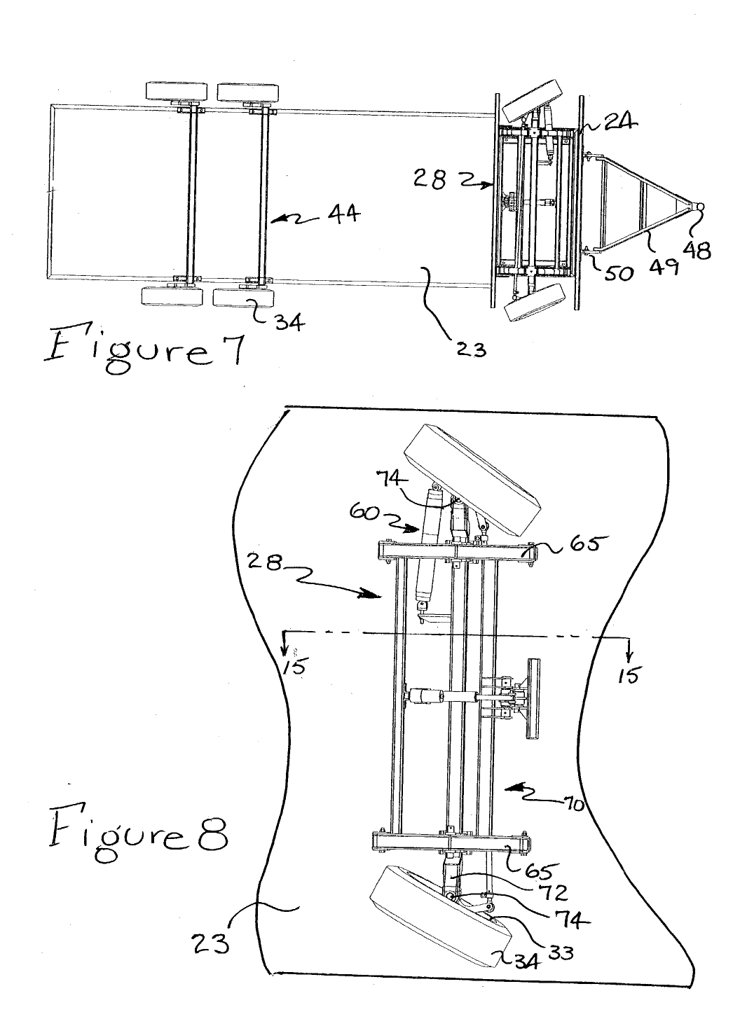

FIGS. 5, 6 and 7 are respectively an isometric view, in elevation and a bottom view of a self-steering trailer 40 constructed in accordance with the present invention. The trailer 40 also comprises a vehicle 10 having a front 14 and a rear 16. The trailer 40 has a tongue 48 for mating with a hitch (not shown) of a pulling vehicle at a forward portion of a support frame 49. The support frame 49 is pivoted to support 50 affixed to the front 14 of the trailer 40 to allow vertical movement of the position of the tongue 48 to engage a hitch. The self-steering trailer 40 has a forward, self-steering axle 28, such as the self-steering axle 28 included in a truck 12 (FIG. 1) and a rear axle assembly 44 which may comprise one or more axles. The axles 28 and axle assembly 44 support the trailer 40 so that a substantially zero tongue weight may be provided at the tongue 48 when coupled to a pulling vehicle.

It is conventional to provide positive caster for a vehicle going in a forward direction. However, when backing, a trailer or tag axle will not back properly. Caster reversal must be provided. While it is known to provide for a caster reversing in trailers, prior arrangements have disadvantages as described above. The present invention provides an effective arrangement for caster reversing in self-steering axles.

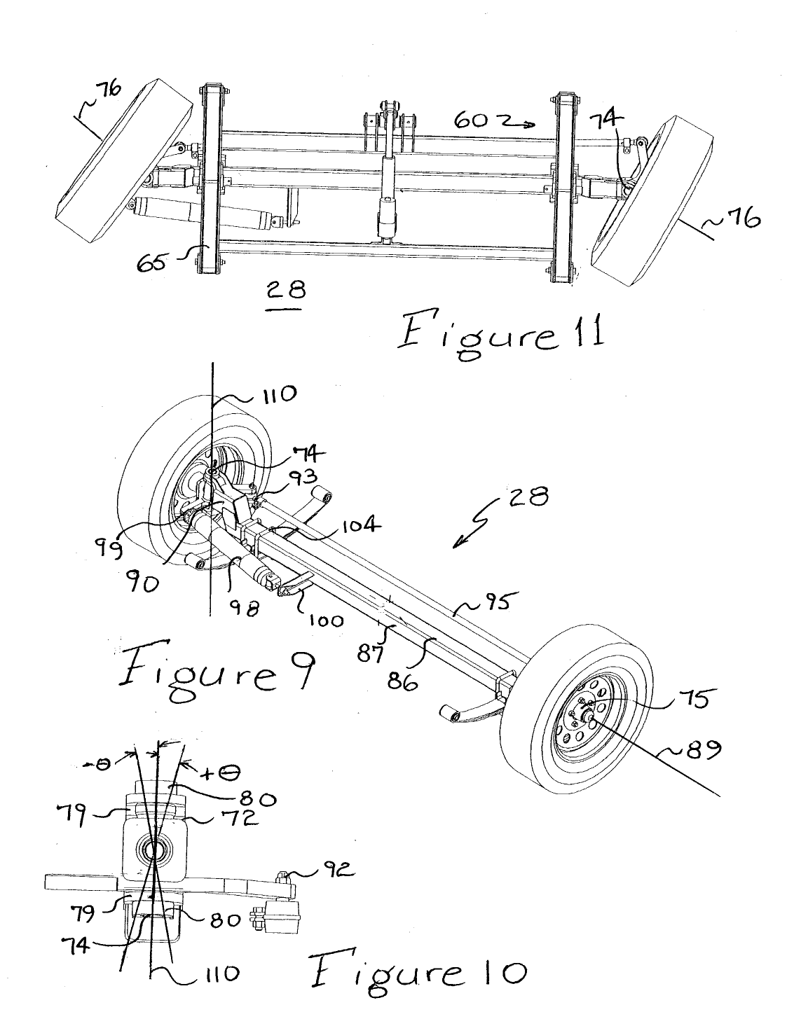

FIG. 8 is a top view of the self-steering axle assembly 28 affixed to and cooperating with a lower surface 30 of a truck or trailer compartment 22. FIG. 9 is an isometric view of the self-steering axle assembly 28. The steering axle assembly 28 includes a suspension assembly 60. The suspension assembly 60 as used in the present description includes steering components, further described below and a suspension member. In the present embodiment, the suspension member comprises leaf springs 65. The steering axle assembly 28 further comprises a platform assembly 70 cooperating with the lower surface 30 and the suspension assembly 60.

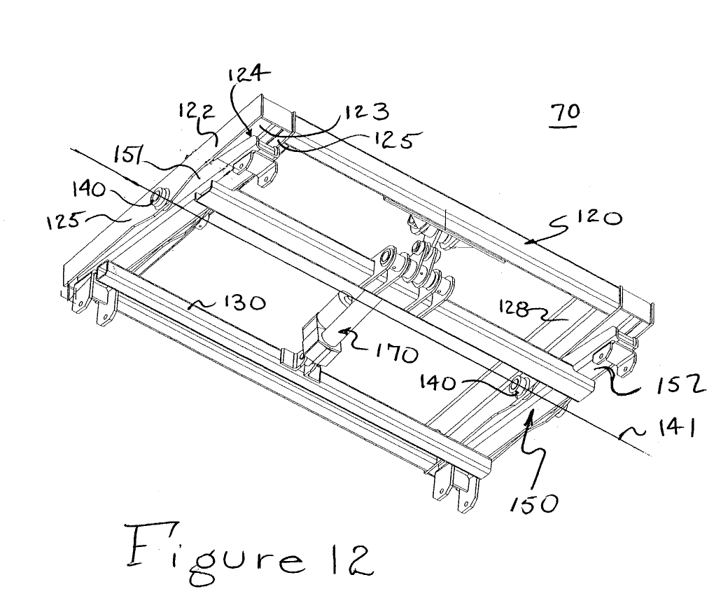

The wheels 33 each rotate in a forward or backward direction around a spindle 75 (FIG. 9) included in hub 32 in a spindle mount 72. Each spindle 75 has a motion axis 76 about which a wheel 33 rotates. The spindle mount 72 mounting each wheel 33 also supports a king pin 74. The wheels 33 pivot about the king pins 74 in order to steer. The suspension assembly 60 is further described with respect to FIG. 9 in which the same reference numerals are used to denote corresponding components. The king pins 74 define steering axes 110 discussed with respect to FIG. 10 below.

The spindle mounts 72 comprise U-shaped brackets 78 having upper and lower arms 79 through which opposite vertical ends of the king pin 74 project. The king pin 74 is secured to the bracket 78 by collars 80. The king pins 74 secure the spindle mounts 72 to opposite ends of a drop-center axle 86. The drop-center axle 86 has a central member 87 and spindle mount supports 90 projecting from opposite ends of the central member 87. The axle 86 defines a motion axis 89 which is normal to a forward direction of travel. The axes 76 of the spindles coincide with the motion axis 89 when the wheels 33 are straight rather than turned.

A steering arm 92 has one end rigidly connected to a lower end of a king pin 74 and an opposite end connected by a pivot connector 93 to a tie rod 95. This connection provides for steering of both wheels affixed to the axle 76 in the same direction in a conventional manner. Tubular dampers 98 have a first end fixed to the spindle unit 72 by a stabilizer arm 99 and a second end pivotally mounted to a shock mount member 100 projecting from the central member 87 of the axle 86. The leaf springs 65 are each fixed to the central member 86 by a conventional U bracket fastener 104.

FIG. 10 is a partial detailed illustration of FIG. 9 illustrating the king pin 74 mounted in the bracket 78 of the spindle assembly 72 but without the spindle mount portion 72 of the axle 86 affixed thereto. In FIG. 10, axis 110 is vertical. Caster is defined as an angle between an axis of the king pin 74 and the vertical axis 110. Caster is positive when the king pin 74 is disposed in a forward direction. For purposes of the present discussion, this means that an upper end of the king pin 74 is farther to the rear 16 (FIG. 1) of a vehicle 10 than the lower end of the king pin 74. Positive caster is illustrated by the angle +θ. Caster is negative when an upper end of the king pin 74 is farther to the front 14 of a vehicle 10. A negative caster angle is represented in FIG. 10 as an angle of −θ. A common value of θ and reversible caster embodiments is 5°. While a number of different values for θ may be used, 5° is a good optimization when trading off the amount of caster needed to be sure that positive or negative caster is maintained versus minimizing the amount of adjustment to the apparatus when changing direction of caster.

FIGS. 11, 12, and 13 are respectively a plan view of the platform assembly 70 cooperating with the suspension assembly 60, an inverted, lower isometric view of the platform assembly 70 and an exploded view of the platform assembly 70 respectively. The platform assembly 70 includes a platform from 120 and a tiltable caster platform 150 further discussed below. Reference is made to these three figures taken together since referenced items may be visible in some views and not others.

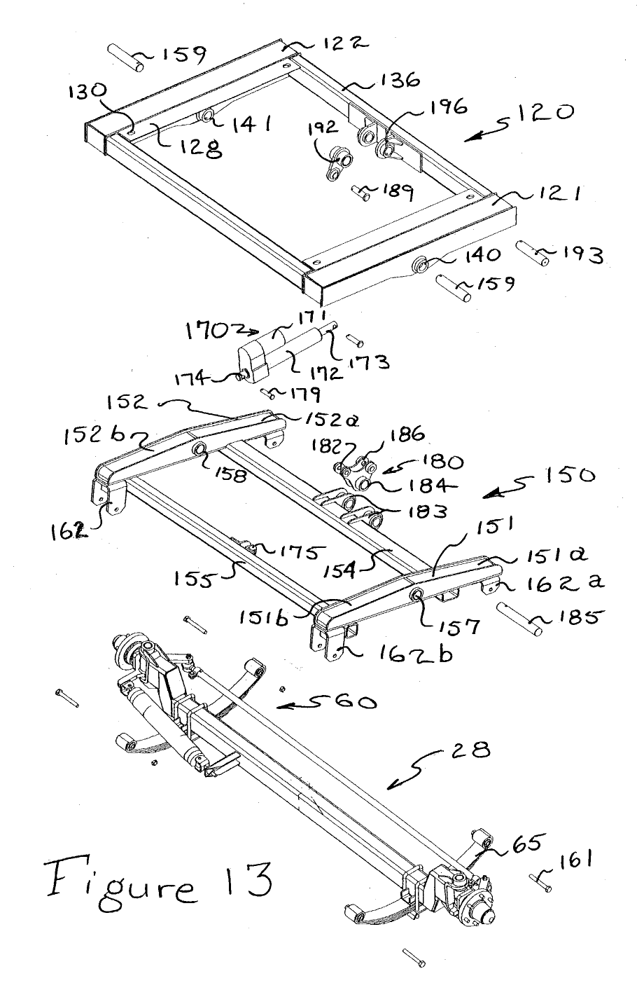

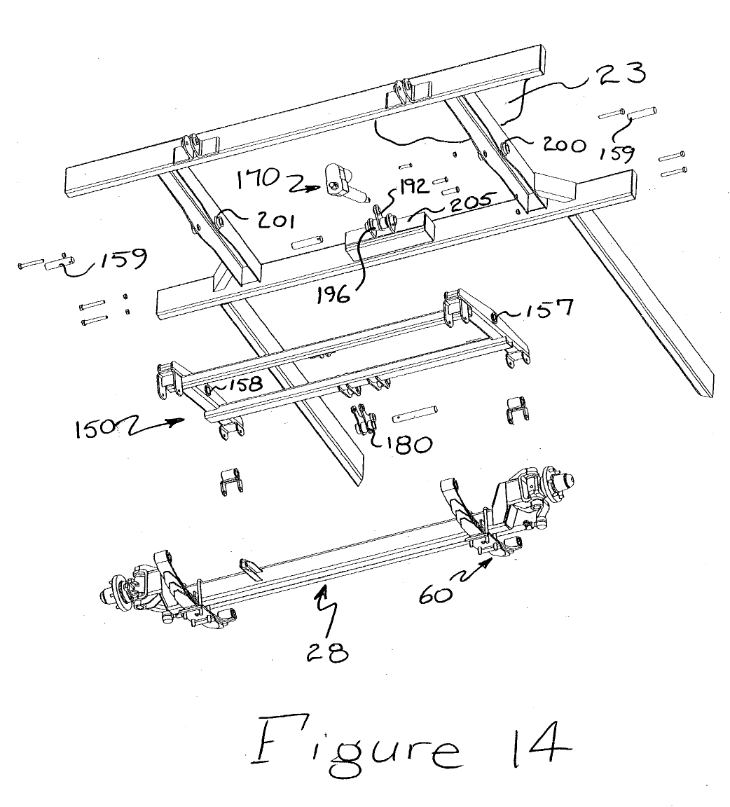

The platform assembly 70 includes a platform frame 120 which comprises longitudinally (i.e., forwardly and rearwardly extending channel members 122 having channels 124 defined on a lower side of the channel member 122 by sidewalls 125. Projecting preferably inwardly from an upper surface of the channel members 122 are mounting flanges 128 by which the platform frame 120 may be secured to a vehicle 12. (It should be noted that as seen, for example, in FIG. 14, the platform assembly 70 may be mounted directly to the vehicle 12, and the platform frame 120 need not be included.) The mounting flanges 128 have apertures 130 through which fasteners 132 (FIG. 13) may project to secure the platform frame 120 to a vehicle 12. Preferably as seen in FIG. 8, the platform frame 120 is secured to the bottom surface 23 of the compartment 22. Each of the channel members 122 includes a longitudinally centrally located set of journal members 140. The journal members 140 define an axis of rotation 141.

A tiltable caster platform 150 (FIG. 12) is provided which is tiltable to a first or second position with respect to the platform frame 130 inwardly defined caster of the axle assembly 28. The platform 150 includes parallel rocker arms 151 and 152, each received in one of the channels 124 (FIG. 12). Each arm 151 and 152 may have an inverted V cross section such that forward halves 151a and 152a of the arms 151 and 152 respectively would be flat against the upper surface 123 of the channel 124 when caster is negative and sections 151b and 152b of the arms 151 and 152 respectively bear against the upper surface 123 of each channel 124 when caster is positive. The arms 151 and 152 are maintained in fixed spacial relationship by forward and rear cross arms 154 and 155.

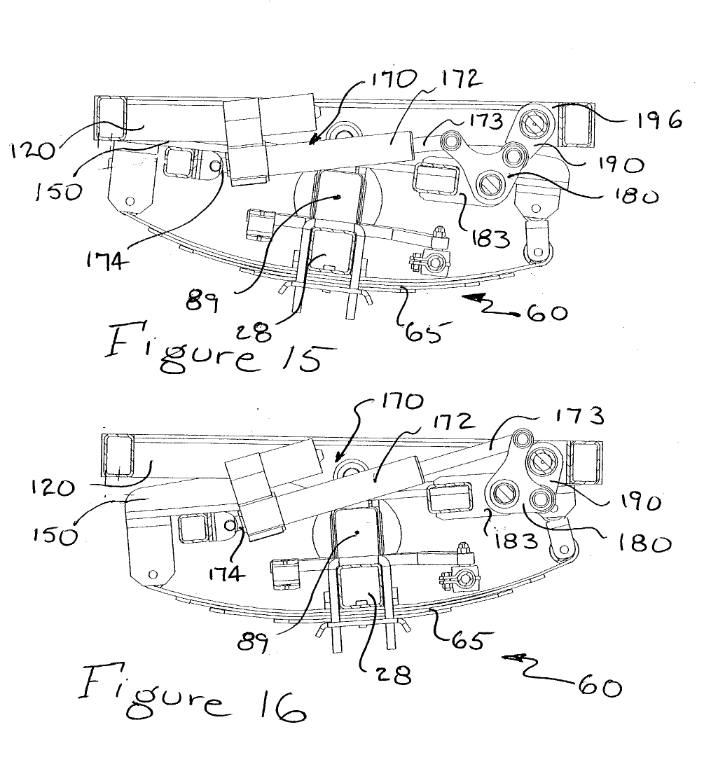

Arms 151 and 152 include longitudinally centrally located journals sleeves 157 and 158 respectively. When the axle assembly 28 is assembled, the arms 151 and 152 are placed in the channels 124. The journal sleeves 157 and 158 are aligned with journal members 140 and 141 respectively. A pivot pin 159 is inserted through the journal member 140 and journal bearing 157. Another pivot pin 159 is inserted through the main journal member 141 and the journal bearing 158. In this matter, the caster platform 150 is pivotally mounted to the platform frame 120. Opposite end of the arms 151, i.e., ends of the arm sections 151a and 151b remote from the journal bearing 157 have mount flanges 162a and 162b projecting downwardly therefrom respectively. In a preferred form, the journal bearings 157 and 158 bear the axle weight of the axle. Each mount flange 162 is fastened, i.e., as by a pin 161 to a leaf spring 65. Similarly, opposite ends of the arm 152 have mount flanges 163 projecting downwardly therefrom for securing to opposite ends of a leaf spring 65, as for example, by utilizing a pin 161. In this matter, the platform 150 is connected to move the axle assembly 28 and suspension assembly 60 into first or second positions as described with respect to FIGS. 15 and 16 below. In order to provide for positioning of the caster platform in the first or second position, an actuator 170 is provided.

The actuator 170 is a device operable to tilt the caster platform 150 to a selected angular position with respect to the platform frame 120, or as illustrated with respect to FIG. 14 below, with respect to the lower surface 23 of the vehicle 12. Many forms of actuators 170 are well-known. Conveniently, the actuator 170 comprises a component having a selectable variable length including a rod or the like telescoping within a housing. Other types of actuators could be used to vary angular displacement of the caster platform 150. Examples of an actuator including a telescoping arm include hydraulic and pneumatic piston and cylinder assemblies and gear-driven mechanical assemblies.

In the particular example illustrated, the actuator 170 comprises an electric motor 171, operating a screw drive 172, in order to drive an actuator rod 173 to either extend from or retract into the screw drive unit 172. The actuator 170 includes an extension 174 which is pivotally secured to a bracket 175 affixed to the rear cross arm 155. A pin 179 secures the extension 174 to the bracket 175. A pivot assembly 180 is provided to rock, tilt or rotate the caster platform 150 in response to movement of the actuator arm 173. A pivot arm 180 has a central journal bearing 184 secured by a pin 185 to a journal mount 183 secured to the forward cross arm 154 of the platform 150. An end of a first leg 182 of the pivot arm 180 is secured by a pin to a forward, or distal, end of the actuator arm 173. A second leg 186 of the pivot arm 180 is secured by a pin 189 to a first end of a link 192. A second end of the link 192 is secured by a pin 193 to a journal mount 196 secured to a forward cross arm 136 of the platform frame 120.

As explained above, the platform frame 120 is an optional component. The caster platform 150 may be mounted so that movement is achieved by pushing or pulling of the actuator 170 against a lower surface 23 of the vehicle 12 itself (FIG. 8). In this embodiment, mounting hardware is affixed directly to the underside 30 of the vehicle 12 as shown in FIG. 14. First and second journals brackets 200 and 201 are affixed to the lower surface 30 to receive the journal bearings 157 and 158 respectively secured thereto by the pins 159. A journal bracket 205 secured to new lower surface 30 receives the forward, or distal, end of the link 192.

Operation is described with respect to FIGS. 15 and 16 which are each a partial cross-sectional view taken along lines 15-15 of FIG. 8. FIG. 15 illustrates the axle assembly in a first position where positive caster is provided. The actuator arm 173 is retracted within the drive unit 172. The actuator 170 is proportioned such that in this position, the arm sections 151b and 152b (FIGS. 13) are positioned against the inner surface 123 of the channel 124 (FIG. 12). The lever unit 180 and link 190 maintain the distal end of the actuator arm 173 at a position with respect to the journal mounting 196 on the platform frame 120 so that the forward arm portions 151a and 152a prevents FIG. 13 are positioned away from the surface 123 of the channels 124 (FIG. 12).

In order to operate the apparatus so that the axle assembly 28 is moved to the second position, electric power is applied to the actuator 170 (as described further with respect to FIG. 21 below) and the actuator arm 173 extends from the drive unit 172. The lever unit 180 is rotated about the journal fitting 184 and the lever arm 182 is positioned to lift the caster platform 150 at the journal bracket 186. As the journal bracket 186 (FIG. 13) is lifted up, the arms 151 and 152 rotate about the axis 141 and the rear or proximal, end of the caster platform 150 is pushed downwardly. Consequently, the distal flange bracket 162 pulls up on the forward end of the leaf spring 65 and the proximal, or rear, flange bracket 162 pushes down on the rear end of the leaf spring 65. In this manner, the entire suspension assembly is rotated about the axis 89 of the axle 86 (FIG. 9) and about the journal bearings 157-158 and 140-141. When the wheels 33 are straight, the axle 89 coincides with an axle of the spindles 75.

The actuator 170 can be reversed after a backing operation is completed. In this case, as the actuator arm 173 is drawn into the drive unit of 172, the caster platform 155 will rotate about the axis 141 to return to the first position. Consequently, the suspension system 60 will rotate about the axis 89 (FIG. 9) and the journal bearings 157-158 to return to the first position. Movement of the suspension system is substantially balanced. The actuator 170 does not need to overcome biasing forces of a suspension system. Consequently, an actuator 70 may be provided which is less costly than an actuator required to do a similar task in prior art systems.

Since the disposition of the axle assembly 28 is dependent on electric power, it is desirable to provide for a fail safe system so that the vehicle 12 may be moved in the forward direction in the event of loss of electrical power. Fail safe operation is provided by a back up battery provided in the vehicle 12 as further described with respect to FIG. 21 below.

The present invention is suited to vehicles and axles including different types of suspensions. The leaf spring suspension is only one example. Another example is a suspension including hydraulic or pneumatic shock absorbers, which include “air bag suspensions.” In order to illustrate specifically one further form of suspension, a torsion self-steer axle suspension is discussed next.

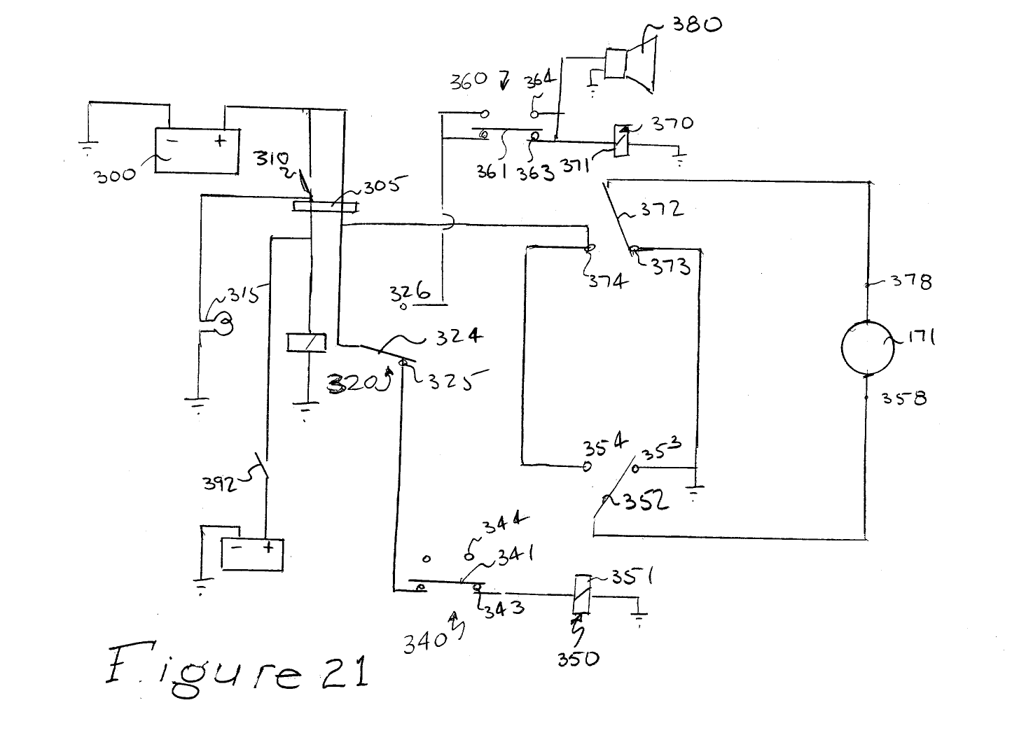

FIGS. 17 through 20 illustrate a further embodiment of the present invention in which an axial assembly 28 comprises a platform assembly 70, including a caster platform 150, interacting with a torsion self-steer axle suspension assembly 260. A suspension assembly 260 includes a main beam number 265 including a pair of torsion bars 267 and 268. The torsion bars 267 and 268 are journalled at one end of the beam 265 and clamped or otherwise fixed to a longitudinal opposite end of the main beam number 265.

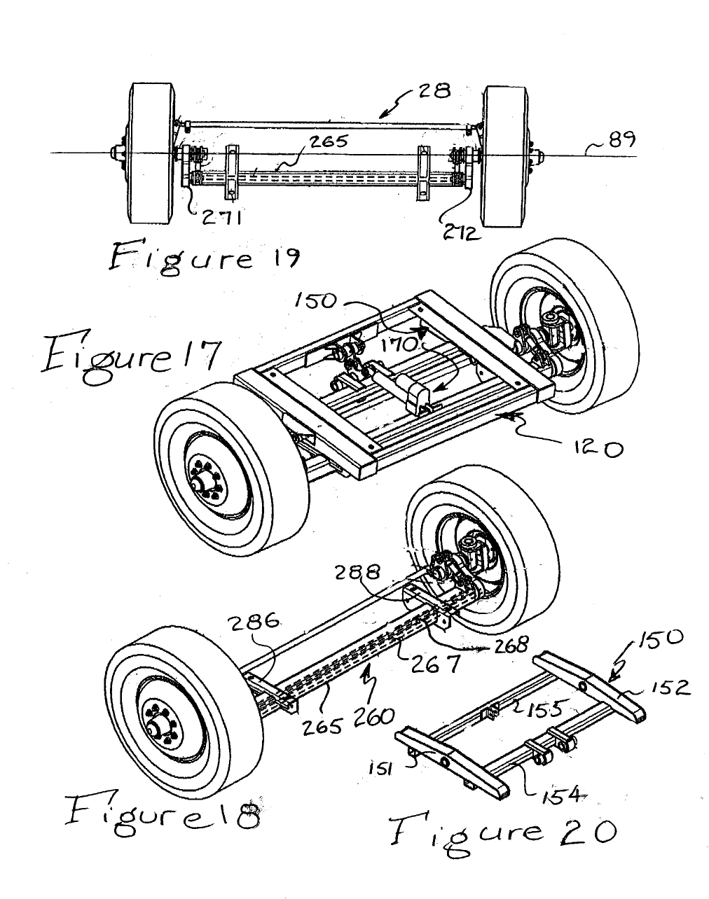

FIG. 17 is an isometric view of the axial assembly 28, FIG. 18 is an isometric view with the caster assembly 70 removed; and FIG. 19 is an elevation of the apparatus of FIGS. 17 and 18. As best seen in FIG. 19, opposite ends of the torsion bar unit 265 are rigidly coupled to a first end of arm members 271 and 272. The arm members 271 and 272 are mounted to the spindle mounts 72 (FIG. 9) so that the suspension assembly 260 is rotatable about the axis 89 (FIG. 17). The caster platform 150 does not include flange brackets 162 or 163. Rather, the main torsion shaft 265 includes rigid cross bars 286 and 288 which affixed to arms 151 and 152 respectively. Consequently, the actuator 170 is in the first position. Arm sections 151b and 152b pull out the rear ends of the members 286 and 288. When the actuator 170 is in the second position, the rear ends of the arms 286 and 288 are down. Here the suspension assembly 260, again is rotated about the axis 89.

FIG. 21 is a schematic diagram illustrating a circuit which may control operation of the present invention. The motor 171 is powered by a car battery 300. Where the vehicle 12 is a trailer, the car battery 300 may be coupled to the motor 171 by a connector module 305. The actuator 170 (FIG. 13) is normally in the first position. When the vehicle 12 is going to be reversed, a reverse gear switch 310 energize a back-up light 315 and a relay 320. The relay 320 is responsive to the voltage thereacross, and may therefore be viewed as a sensor which senses entry of the vehicle 12 in reverse gear. Voltage from the battery 13 is a signal indicative of the vehicle 12 being in reverse gear.

The relay 320 operates a switch 324 to connect the battery 300 to a terminal 325 in a first position or a terminal 326 in a second position. In the first position, of the switch 324 the circuit is enabled to energize the motor 171 to operate the actuator 170 to reach its first position and then stay there. In the second position of the switch 324, the circuit is enabled to energize the motor 171 to operate the actuator to reach its second position and stay there.

The terminal 325 is in series with a limit switch 340 including a contactor 341 selectively connected across closed contact pair 343 or contact pair 344. A relay coil 351 of a relay 350 is connected between the contact pair 343 and ground. A switch 352 in a first position connects a first terminal 358 of the motor 71 to a terminal 354 connected to the battery 300. In a second position, the switch 352 connects the motor terminal 358 to switch terminal 358 and ground. Similarly, the terminal 326 is connected to a limit switch 360 having a contactor 36 connected across contact pair 363 or contact pair 364. A relay 370 has a coil 370 connected between the relay contact pair 363 and ground. An alarm 380 is connected between both the contact pair 363 and the contact pair 364 and ground. A switch 372 connects a second terminal 378 of the motor 171 to a terminal 374 coupled to the battery 300 in a first position and in a second position connects the terminal 378 to a switch terminal 373 and ground. A back-up battery 390 on the vehicle 12 may be connected to the circuit 392 to return the system to positive caster the battery 300 is disconnected.

In operation, prior to entry of the axle assembly into the positive caster state, the limit switch 340 is closed. The switch 310 is opened when the vehicle 12 is taken out of reverse gear. The relay coil 320 is de-energized and the switch 324 connects the battery 300 to the terminal 325 and to the coil 351 via the limit switch 340. The relay 350 operates the switch 352 to connect the terminal 358 of the motor 171 to the terminal 354 and battery 300. This connects a first polarity of voltage across the motor 171 and to operate the screw drive unit 172 (FIG. 13) to retract the actuator rod 173. When the actuator unit 170 reaches its first position corresponding to positive caster, the limit switch 340 opens. The contactor 341 is moved to open contacts 374. The contact pair 343 is opened. The relay coil 351 is de-energized. The switch 352 connects terminal 358 to terminal 353, and ground. The motor 171 is de-energized. Also, contactor 361 in limit switch 360 closes contact pair 363.

When the vehicle 12 is placed in reverse, switch 310 closes. Coil 320 is energized to operate switch 325 to connect the battery 300 via limit switch 360 to energize alarm 380 and relay coil 370. Relay coil 370 operates switch 372 to connect motor terminal 378 to terminal 374 and battery 300. A second polarity voltage is connected across the motor 171. Now the screw drive unit 171 operates to extend the actuator rod 173. When the actuator rod 173 moves to an extent so that the actuator 170 reaches its second position, corresponding to a particular negative caster, contactor 361 opens contact pair 363 and closes contact pair 364. Consequently, coil 371 is de-energized so motor terminal 378 is disconnected from the battery 300 and again connected to the terminal 373 and ground. The motor 171 is de-energized. Since contacts 364 are closed, the alarm 380 remains actuated while the vehicle 12 is in reverse. Also, when the actuator 170 reaches the second position, contactor 341 in limit switch 340 closes contacts pair 343.

When the vehicle 12 is taken out of reverse, switch 310 is opened, and the operation described above of going from negative caster the positive is repeated.

The specification has been written with a view toward enabling those skilled in the art to provide many different embodiments, each in accordance with the present invention.

What is claimed is:

1. A steerable axle assembly comprising:
a steering system including spindles that receive wheels and rotate on a motion axis, a spindle mount supporting each said spindle for rotation on a steering axis, said steering assembly having a caster corresponding to an angle between said steering axis and a reference axis, and a suspension system mounted to said steering system, said suspension system and said steering system being pivotal as a unit around said motion axis.

2. A steerable axle assembly according to claim 1 further comprising an arm coupled to apply movement to said suspension assembly to rotate said steering assembly about said motion axis to change caster.

3. A steerable axle assembly according to claim 2 wherein said spindle rotates within a hub.

4. A steerable axle assembly according to claim 3 further comprising an actuator connected to said platform for moving said arm.

5. A steerable assembly according to claim 4 wherein said arm is connected to a tiltable platform.

6. A steerable assembly according to claim 5 wherein ends of said tiltable platform are connected to ends of said suspension system said ends of said platform being located forwardly and rearwardly of said motion axis.

7. A steerable axle assembly according to claim 6 in which said platform is journalled to tilt, and wherein tilting of said platform applies force in opposite direction to said suspension system forwardly, and rearwardly, of said motion axis and wherein said platform is linked to said suspension system.

8. A steerable axle assembly according to claim 7 in which positions are defined on said actuator each corresponding to a positive and negative caster.

9. A steerable axle assembly according to claim 8 wherein said platform comprises journal bearings for pivotal mounting of said platform.

10. A steerable axle assembly according to claim 9 wherein said journal bearing supports axle weight of the vehicle.

11. A steerable axle assembly according to claim 9 further comprising a mounting frame for mounting to a vehicle and pivotally connected to said platform.

12. A steerable axle assembly according to claim 11 wherein said actuator has a first end mounted to said mounting frame and a second end mounted to said platform.

13. A self-steerable subassembly comprising:
a platform journalled to be pivotable with respect to a vehicle surface plane;
spindle units defining a motion axis and a steering axis;
a suspension system linked intermediate said spindle units and said platform;
said spindle supports linked to said suspension to have a caster angle in accordance with an angular position of the suspension with respect to the motion axis; and
links between said suspension system and said platform to determine the angular position of said suspension system in correspondence with an angular position of said platform.

14. The self-steerable subassembly of claim 13 wherein said links between said platform and said suspension system comprise at least a link forward of the motion axis and a link rearward of the motion axis.

15. The self-steerable subassembly of claim 14 comprising an axle defining the motion axis in supporting a spindle unit at either end thereof and connected to said suspension system.

16. The self-steerable subassembly of claim 15 wherein said suspension system comprises leaf springs extending forwardly and rearwardly of said axis.

17. A self-steerable subassembly according to claim 15 wherein said axle comprises a torsion bar offset from said motion axis and crank arms linking said torsion bar to spindle units at said motion axis and wherein said crank arms are coupled to said platform to change angular displacement of said axle with respect to said motion axis in response to tilting of said platform.

18. The self-steerable subassembly of claim 15 further comprising an actuator having a first end coupled to said platform and a second end linked to the vehicle surface plane so that the degree of extension of said actuator determines the inclination of said platform.

19. The self-steerable subassembly of claim 16 wherein first and second extension positions are defined of said actuator to provide a preselected positive and a preselected negative caster.

20. The self-steerable subassembly of claim 17 wherein said actuator comprises an electric motor and screw drive.

21. The self-steerable subassembly of claim 17 further comprising an actuator having a first end coupled to said platform and a second end linked to said vehicle surface plane so that the degree of extension of said actuator determines the inclination of said platform.

22. The self-steerable subassembly of claim 17 wherein first and second extension positions of said actuator are defined to provide a preselected positive and a preselected negative caster.

23. The self-steerable subassembly of claim 16 further comprising a frame to be affixed to a reference surface of a vehicle and wherein said platform is journalled for pivoting in on said frame.

24. In a self-steerable vehicle comprising a frame, a steering unit, and a suspension and caster determining means, the improvement wherein said caster-determining means comprises a platform pivotally mounted with respect to said frame, said platform being positioned above a motion axis, said platform being linked to tilt said suspension as a unit with respect to said motion axis, said suspension being linked to a spindle unit to determine the caster angle of a spindle unit with respect to the motion axis.

25. The improvement according to claim 24 comprising an actuator coupled between said platform and said vehicle.

26. The improvement according to claim 25 wherein first and second extension positions of said actuator are defined to provide a preselected positive and a preselected caster.

27. The improvement according to claim 26 wherein said actuator comprises an electric motor and screw drive.

28. A steerable vehicle comprising:
a vehicle reference surface,
a self-steering unit and a suspension unit linked to be rotatable as a whole about a motion axis , said steering unit comprising a spindle unit defining a caster in accordance with angular displacement of said spindle unit with respect to said motion axis;
a platform pivotally mounted to said vehicle reference surface and linked to said steering unit and said suspension unit to determine the angular position thereof.

29. The steerable vehicle according to claim 28 comprising an actuator coupled between said platform and said vehicle.

30. The steerable vehicle according to claim 29 wherein first and second extension positions of said actuator are defined to provide a preselected positive and a preselected caster.

31. The steerable vehicle according to claim 30 wherein said actuator comprises an electric motor and screw drive.

32. A trailer comprising:
a vehicle reference surface,
a self-steering unit and a suspension unit linked to be rotatable as a whole about a motion axis , said steering unit comprising a spindle unit defining a caster in accordance with angular displacement of said spindle unit with respect to said motion axis;
a platform pivotally mounted to said vehicle reference surface and linked to said steering unit and said suspension unit to determine the angular position thereof.

33. The trailer according to claim 32 comprising an actuator coupled between said platform and said vehicle.

34. The trailer according to claim 33 wherein first and second extension positions of said actuator are defined to provide a preselected positive and a preselected caster.

35. The trailer according to claim 34 wherein said actuator comprises an electric motor and screw drive.

36. A method for setting caster in a self-steerable assembly comprising a steering unit and suspension unit, said steering unit including an axle defining a motion axis and having a spindle unit defining a caster axis, said method comprising rotating said steering unit and suspension with respect to said motion axis.

37. The method of claim 36 further comprising providing a member intermediate said steering and suspension unit and the reference surface of said vehicle pivotally linked to the underside of said unit and linked to apply a force to said steering and suspension unit to cause rotation about the motion axis and tilting said member to determine angular displacement of the steering and suspension unit.

38. The method of claim 37 further comprising providing an actuator intermediate member and said vehicle reference surface and setting the length of said actuator to determine angular disposition of the intermediate member.

39. The method of claim 38 further comprising selecting particular extension lengths of said actuator to determine a preselected positive and a preselected negative caster.

40. The method of claim 39 further comprising operating said actuator in response to a signal indicative of gear selection for said vehicle.

41. The method according to claim 40 wherein the step of operating comprises moving said actuator to the length indicative of negative caster in response to actuation of a backup light in said vehicle.
